(19) United States
(12) Patent Application Publication
(10) Pub. No.: US 2007/0009411 A1
(43) Pub. Date: Jan. 11, 2007

(54) Method and apparatus for particulate removal and undesirable vapor scrubbing from a moving gas stream

(75) Inventors: Isaac Ray, Brooklyn, NY (US); Mark A. West, Deerfield, IL (US); Boris Altshuler, North Miami Beach, FL (US)

Correspondence Address: GARDNER CARTON & DOUGLAS LLP;ATTN: PATENT DOCKET DEPT., 191 N. WACKER DRIVE, SUITE 3700, CHICAGO, IL, 60606, US

(73) Assignee: Eisenmann Corporation, Crystal Lake, IL (US)

(21) Appl. No.: 11/482,455

(22) Filed: Jul. 7, 2006

Related U.S. Application Data
(60) Provisional application No. 60/697,782, filed on Jul. 8, 2005.

(51) Int. Cl. B01D 53/46

(52) U.S. Cl. 423/210

(57) ABSTRACT

An apparatus and method for removing particulate matter and undesirable vapors from a gas stream are provided. In one aspect, an apparatus includes at least one ionizing electrode that negatively charges the particulate matter and condensed droplets of undesirable vapors, at least one scrubbing element including a collecting surface, and at least one liquid applicator operable to apply a liquid film to the collecting surface, wherein a positive charge is applied to the liquid film to attract negatively-charged particulate matter and/or condensed droplets of undesirable vapors to the collecting surface. In another aspect, a method includes the steps of: negatively charging the particulate matter and condensed droplets of undesirable vapors using at least one ionizing electrode; applying a liquid film to a collecting surface proximate the ionizing electrode; and positively charging the liquid film to attract the negatively-charged particulate matter and condensed droplets of undesirable vapors.

### CROSS-REFERENCE TO RELATED PATENT APPLICATIONS

This patent application claims the benefit of U.S. Provisional Patent Application No. 60/697,782, filed Jul. 8, 2005.

### FIELD OF THE INVENTION

This invention pertains to a method and apparatus for particulate matter removal and for undesirable vapor scrubbing from a gas stream.

### BACKGROUND OF THE INVENTION

There have been continuing attempts to improve techniques for removing fine particulates from gas streams. In conventional systems, contaminated gas streams are typically cleansed of particulate matter by charging the particular matter in a charging section of an apparatus. The residence time for the gas within the charging section of such conventional apparatuses, however, is typically very low and, therefore such systems do not provide for substantial collection of particulate matter following charging. Moreover, the collection and removal of negatively-charged particles from a gas stream in conventional systems and methods typically occurs in neutral scrubbers. In this regard, the attraction forces between the negatively-charged particles and neutral collecting surfaces (packing) in conventional systems is typically very weak and, therefore, necessitates the maintenance of low gas stream velocity through the system in order to obtain efficient removal of submicron particles. This limitation, in turn, typically calls for larger and more expensive equipment.

A need remains, therefore, for improved and cost effective apparatuses and methods for eliminating all or substantially all of a particulate matter and undesirable vapors from a gas stream, while continuously cleaning the collecting surface.

### BRIEF SUMMARY OF THE INVENTION

In one aspect the invention provides an apparatus for removing particulate matter and undesirable vapors from a gas stream containing particulate matter and undesirable vapors, wherein the apparatus comprises at least one ionizing electrode that negatively charges the particulate matter and condensed droplets of undesirable vapors, at least one scrubbing element that includes a collecting surface, and at least one a liquid applicator operable to apply a liquid film to the collecting surface, whereby a positive charge is applied to the liquid film to attract negatively-charged particulate matter and condensed droplets of undesirable vapors to the liquid-covered collecting surface.

In another aspect the invention provides a method for removing particulate matter and undesirable vapors from a gas stream containing particulate matter and undesirable vapors, the method comprising: negatively charging the particulate matter and condensed droplets of undesirable vapors using at least one ionizing electrode; applying a liquid film to a collecting surface proximate the ionizing electrode; and positively charging the liquid film to attract the negatively-charged particulate matter.

One embodiment of the invention provides a highly efficient and compact apparatus and method for removing both particulate matter (e.g., PM-10 and PM-2.5) and undesirable vapors from a gas stream substantially simultaneously or simultaneously.

### BRIEF DESCRIPTION OF THE DRAWINGS

FIG. 1 is a schematic, side elevation, with portions broken away, of an example apparatus for removing particulate matter and undesirable vapors from a gas stream;

FIG. 2 is a schematic diagram of an example apparatus having a single pass configuration for removing particulate matter and undesirable vapors from a gas stream;

FIG. 3 is a schematic, sectional, plan view of example scrubbing elements for the apparatuses of FIGS. 1 and 2;

FIG. 4 is a schematic, sectional, side elevation of the assembly of FIG. 3;

FIG. 5 is schematic side elevation of an example ionizing electrode for the apparatuses of FIGS. 1 and 2; and

FIG. 6 is a perspective view of the ionizing electrode of FIG. 5.

### DETAILED DESCRIPTION OF THE EMBODIMENTS

In one aspect, an apparatus is provided for removing particulate matter and undesirable vapors from a gas stream containing particulate matter and undesirable vapors. An example apparatus comprises at least one ionizing electrode that negatively charges the particulate matter and undesirable vapors, at least one scrubbing element including a collecting surface, and at least one liquid applicator operable to apply a liquid film to the collecting surface, wherein a positive charge is applied to the liquid film to attract negatively-charged particulate matter and/or undesirable vapors to the collecting surface.

In another aspect, a method is provided for removing particulate matter and undesirable vapors from a gas stream. An example method comprises the steps of: negatively charging the particulate matter and undesirable vapors using at least one ionizing electrode; applying a liquid film to a collecting surface proximate the ionizing electrode; and positively charging the liquid film to attract the negatively-charged particulate matter and vapors. Another example method includes the steps of: delivering scrubbing liquid into a scrubbing element that is appropriate for the removal of undesirable vapor from a moving gas stream; and configuring the scrubbing element in the moving gas stream to provide intimate contact between the molecules of undesirable vapors and a film of scrubbing liquid flowing on a surface of the scrubbing element for efficient absorption.

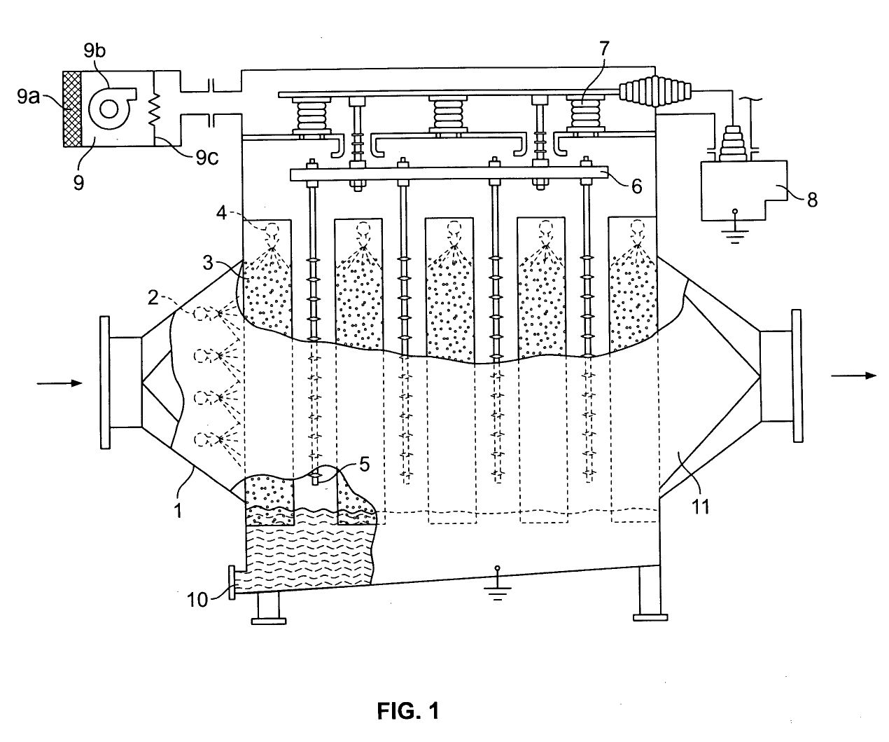

Turning now to the Figures, example apparatuses and methods are described. FIG. 1 illustrates an example apparatus for removing particulate matter and undesirable vapors from a gas stream. As shown, the apparatus comprises a housing including a gas stream inlet transition 1 and a gas stream outlet transition 11. Configured in the housing are spray nozzles 2, scrubbing elements 3 that include collecting surfaces, liquid applicators 4, ionizing electrode 5, a support frame 6 and insulators 7. The apparatus also includes a high voltage source 8, air-purge system 9, and sump 10. As shown, the example apparatus includes five scrubbing elements 3 configured such that a first scrubbing element 3 is disposed at the inlet transition 1 (i.e., the inlet scrubbing element), a second scrubbing element 3 is disposed at the outlet transition 11 (i.e., the outlet scrubbing element) and three intermediate scrubbing elements 3 are arranged between the inlet and outlet scrubbing elements 3. Although five scrubbing elements 3 are illustrated, fewer or additional scrubbing elements 3 could be provided as desired. As further shown, the example apparatus includes four ionizing electrodes 5 configured in an alternating arrangement with the scrubbing elements 3. That is, one ionizing electrode 5 is sandwiched between or otherwise configured between and proximate to two scrubbing elements. Of course, fewer or additional ionizing electrodes 5 could be provided and configured otherwise, for example, according to the number of scrubbing elements 3.

The example apparatus may operate as follows: a gas stream contaminated with (or containing) particulate matter and/or undesirable vapors (e.g., acid vapors, acid gases, or toxic gases, such as, for example, SO₂, NOₓ, or HCl) enters the apparatus through the inlet transition 1. Spray nozzles 2 that are configured in the inlet transition 1 provide continuous self-cleaning of a collecting surface (e.g., a front panel perforated plate) of the inlet scrubbing element 3 (i.e., the scrubbing element 3 that is configured proximate to the inlet transition 1) to reduce and/or remove particulate matter that may tend to accumulate on the incident collecting surface. Scrubbing elements 3, which may comprise front and back perforated plates, are filled with scrubbing packing, which can be selected, for example, according to the chemistry of the process, the particulate matter involved, and the gas scrubbing requirements, in a manner known to those of skill in the art. A scrubbing liquid is delivered by a liquid applicator 4, such as spray header, and flows downward (e.g., by gravity) film-wise or sheet-wise on the collecting surfaces of scrubbing elements 3 to the bottom of the housing and toward sump 10. The scrubbing liquid forms a substantially continuous or continuous liquid film on the collecting surfaces of the scrubbing elements 3 and enables highly active interaction between the moving gas stream and the collecting surfaces of scrubbing elements 3, thereby facilitating the removal of electrically-charged particles and/or undesirable vapors.

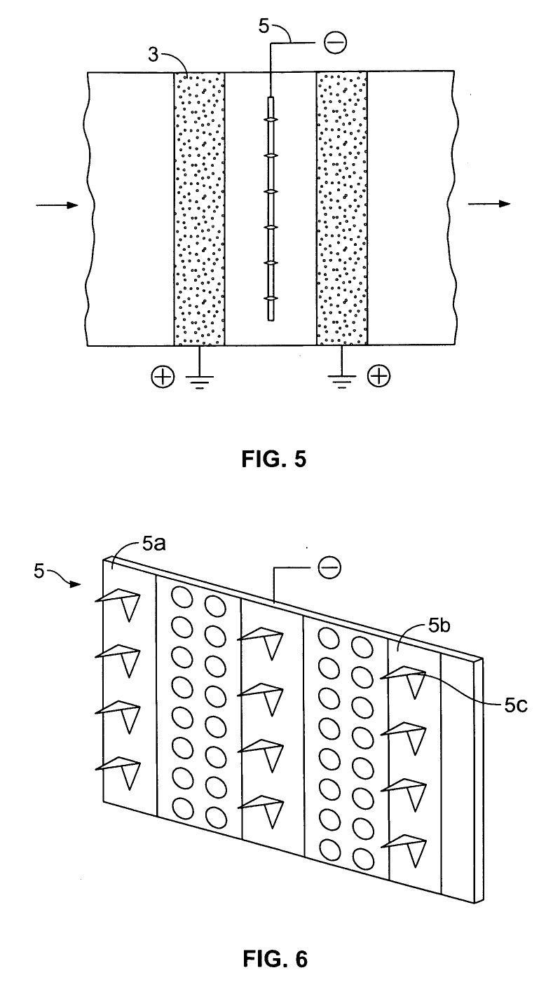

As illustrated in FIG. 1, the at least one ionizing electrode 5 can be adjacent to (e.g., between, juxtaposed among, or proximal to) each of the respective scrubbing elements 3. In some embodiments ionizing electrodes 5 are preferably negatively-charged by a high voltage source 8. Ionizing electrodes 5 may be constructed of any suitable material and may have various configurations as desired. Example ionizing electrodes 5 are depicted in FIGS. 5 and 6 as being constructed of metal and in an array of vertical rods or strips with sharp ionizing points or needles. However, as can be appreciated, the scrubbing elements 3 and the ionizing electrodes 5 can be oriented and configured in any suitable way with respect to each other to promote the charging and collection of particles from the gas stream. Additionally as shown in FIG. 1, a support frame 6 can connect all ionizing electrodes 5 to a common support beam or bus that is electrically isolated from the housing by insulators 7. In some embodiments, the insulators 7 and common support beam or bus may be configured in a compartment that is substantially isolated from the gas stream so as to prevent accumulation of particulate matter on insulators 7 to prevent corona discharge, short-circuiting of the voltage source 8 or the like. As shown, the compartment housing insulators 7 may be supplied with hot clean ambient air by an air-purge system 9 including a filter 9a, a blower 9b, and an electric heater 9c.

The scrubbing liquid used in the apparatus to apply a liquid film to the collecting surface of the scrubbing elements 3 can be any suitable liquid for use in removing and/or scrubbing particulate matter and undesirable vapors from a gas stream. The scrubbing liquid may be, for example, water with a suitable scrubbing reagent (e.g. sodium hydroxide), etc. Moreover, it is preferable for the scrubbing liquid to have as a chemical property the ability to maintain or sustain electrical charges (e.g., positive charges) applied to the liquid by a contact or conductor, even when in the form of a liquid film on the collecting surface. Choice of a suitable scrubbing liquid depends, for example, on the specific particulate matter and/or undesirable vapors that are sought to be removed from a particular gas stream, as is understood by those of skill in the art. The scrubbing liquid can be delivered to the collecting surfaces of scrubbing elements 3 in any suitable manner such as spraying, gravity feed, etc.

The scrubbing elements 3 and their collecting surfaces used in the context of the present invention can be constructed of a variety of suitable materials. In an embodiment, the scrubbing elements 3 are constructed to provide a charge conducting surface to which charged (e.g., negatively-charged) particulate matter and/or undesirable vapors are attracted (e.g., through electrostatic precipitation processes). In one embodiment, the collecting surface of a scrubbing element 3 is constructed partially or entirely of a conductive material (e.g., a metal) to which an electrical charge (e.g. positive polarity) is applied. In another embodiment, for example the scrubbing elements 3 and collecting surfaces may be constructed, at least partially, of a non-conductive material (e.g., plastic). An electrical contact is provided to apply an electrical charge to the film of scrubbing liquid on the collecting surfaces of scrubbing elements 3. In either embodiment, a substantially continuous or continuous film of scrubbing liquid is preferably applied to the surface of the collecting surfaces of scrubbing elements 3 by a liquid applicator 4, which may include a spray nozzle or the like, to provide continuous cleaning of the collecting surfaces and enhanced collection operation.

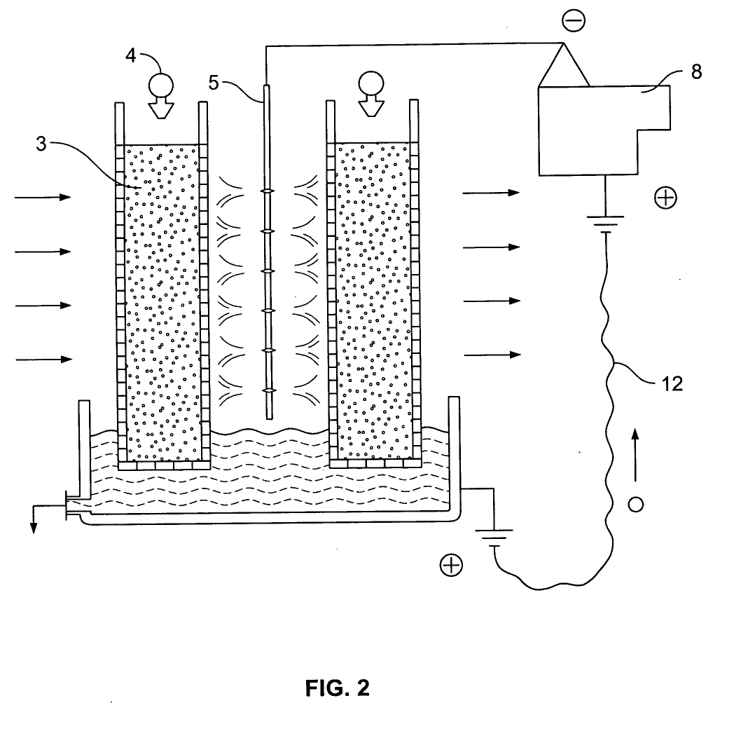

An electrical contact is configured on the apparatus to charge (e.g., positively) the liquid film in a suitable manner. In an embodiment, a charge is applied to the liquid film by at least one contact that applies a charge to a liquid body in conductive contact with the film. As can be appreciated from FIG. 1, a body of liquid that collects in the bottom of the housing and in the sump 10 is in direct, intimate contact with the housing. Lower portions of the film-covered collecting surfaces of the scrubbing elements 3 are submersed in the liquid body, which is formed by the scrubbing liquid that flows from the scrubbing elements 3, that is at a non-neutral potential. As shown in FIG. 1, the housing may be grounded or otherwise configured at a desired potential (e.g., a potential opposite to the potential of ionizing electrodes 5) to increase attraction of ionized particulate matter to the scrubbing elements 3. As shown in FIG. 2, a negative terminal of the voltage source 8 is connected to the ionizing electrodes 5 whereas a positive terminal of the voltage source 8 is connected to ground (earthed). Furthermore, the housing of the apparatus is connected to ground so that the scrubbing liquid, which may recirculate from the body or pool of liquid, facilitates efficient removal of particulate matter and vapors from the gas stream. The substantially continuous liquid film can in this manner form a medium of conductivity (e.g., through which a positive charge can be maintained) along and/or across all or substantially all of the collecting surfaces of the scrubbing elements 3, that is, from the top portion of the scrubbing elements 3, which is proximal to the liquid applicators 4, to the housing and the sump 10. In some embodiments, the sump 10 has a ground connection. In other embodiments, the sump 10 and the housing have ground connections. As can be appreciated, the voltage source 8 may be a high voltage transformer or generator which includes a positive terminal that makes the collecting surfaces (e.g., the surfaces of the collecting surfaces) function as positively charged collecting elements or electrodes.

In another embodiment, a charge is applied to the liquid film by a contact that is located on or in direct contact with the collecting surface. The contact can be a conductive element located on the surface, or in the case of a scrubbing element made of a conductive material, the entire scrubbing element can act as a contact to the film.

Particulate matter and/or undesirable vapors of a contaminated gas stream enters the space between the scrubbing elements 3 and ionizing electrode 5 and the particulate matter in the gas stream become charged due to the high voltage being applied to the electrodes 5. A corona discharge of negative ions flowing between the ionizing electrodes 5 and the collecting surfaces 3 occurs due to the high voltage corona effect. The negatively-charged particulate matter is then attracted to the packing of scrubbing elements 3 (which can be grouped and can have positively-charged collecting surfaces) and to the scrubbing liquid film flowing thereon. A continuous downward flow of scrubbing liquid on the collecting surfaces of scrubbing elements 3 then moves the attracted particulate matter and precipitated product of reaction between the scrubbing liquid and undesirable vapors downward to the sump 10 and drain to be filtered and/or disposed of. After the treatment of the gas stream in the apparatus is complete, the gas stream exits through the outlet transition 11. The charges (electrons) from the negative ions can be circuited back to the voltage source 8, thereby completing the electrical circuit (as depicted at point 12 in FIG. 2).

A schematic of a single pass apparatus is illustrated in FIG. 2. In particular, the single pass apparatus is depicted as comprising two scrubbing elements 3, an ionizing electrode 5 configured between the two scrubbing elements 3, a high voltage source 8, and electrical high voltage connections. Additionally, a gas stream is depicted by directional arrows as passing through the apparatus. The apparatus depicted in FIG. 2 can operate in any suitable manner such as in the manner described above with respect to the apparatus of in FIG. 1. As can be appreciated, the apparatus illustrated in FIG. 1 may have a modular structure and comprise one or more scrubbing modules that are single pass apparatuses, wherein each single pass apparatus is configured differently for treating a different particulate matter or vapor.

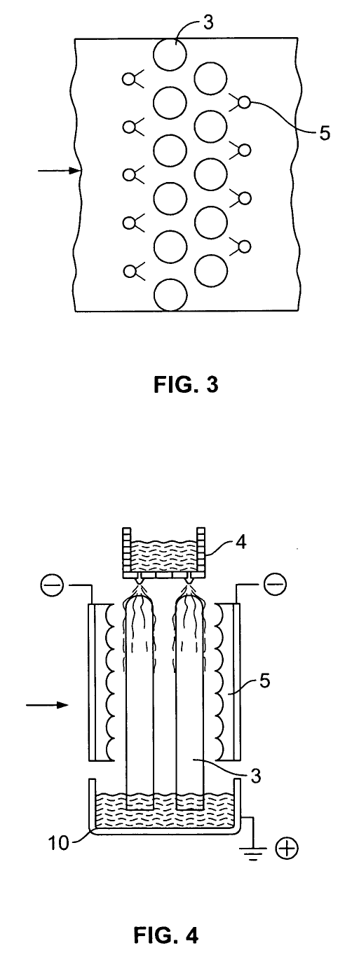

The scrubbing elements 3 and the ionizing electrodes 5 used in the context of the present invention can be configured, situated, and oriented (e.g., with respect to each other) in any manner that is suitable for the charging of particulate matter and condensed droplets of undesirable vapors contained within a gas stream and the subsequent and/or simultaneous attracting of charged particulate and/or condensed droplets of undesirable vapors to the collecting surfaces. In some embodiments, the collecting surfaces of the scrubbing elements 5 may be oriented in a direction substantially perpendicular or perpendicular to the direction of the flow of the gas stream. In an example wherein the gas stream to be scrubbed flows in a substantially horizontal direction, the scrubbing elements 5 may be substantially vertically oriented so that the scrubbing liquid flows by gravity. FIGS. 3 and 4 illustrate an exemplary assembly for use with the apparatuses of FIGS. 1 and 2 wherein the assembly comprises scrubbing elements 3 and ionizing electrodes 5. In particular, as illustrated in FIG. 3, the collecting surfaces of scrubbing elements 3 are cylindrically-shaped (e.g., as vertical rods or tubes) with ionizing electrodes 5 being juxtaposed or spaced adjacently to the scrubbing elements 3. The scrubbing elements 3 may be configured in two rows such that the scrubbing elements 3 of one row are offset with respect to the other row. As can be appreciated, each row of the ionizing electrodes 5 may be connected to a separate power source for redundancy, emergency backup, or the like.

FIGS. 5 and 6 illustrate an exemplary embodiment of ionizing electrodes 5. The ionizing electrodes 5 are constructed from a plastic perforated plate 5a with alloy steel strips 5b coupled thereon or therewith, wherein the strips 5b include an array of formed (e.g., punched-out) sharp ionizing needles 5c that project outward from front and back planar surfaces of the plate 5a.

An electrical field is preferably maintained between the collecting surfaces of scrubbing elements 3 (e.g., positively-charged collecting surfaces) and the negatively-charged ionizing electrodes 5. In this regard, as discussed above, when particulate matter and/or undesirable vapors enter the space between the scrubbing elements and negative high voltage electrodes, the particulate matter and/or condensed droplets of undesirable vapors become charged (e.g., by a corona discharge that is taking place between the ground and high voltage). The negatively-charged particulate matter and/or condensed droplets of undesirable vapors pass through the positive grounded collecting surfaces and are attracted to the surface of the collecting surfaces and/or to the film of scrubbing liquid on the surface of the scrubbing elements. Thus, collected particles and/or condensed droplets of undesirable vapors are removed from the gas stream and are carried from the apparatus to discharge by a recycle liquid. The presence of an electrical field between the grounded (positive) collecting surfaces and ionizing (negative) electrodes, in this regard, allows for treatment of a high-velocity flow gas stream, while maintaining high efficiency of particulate matter and undesirable vapor removal by an absorption process similar to the conventional cross flow pack-bed scrubber.

The apparatuses and methods described herein provide for excellent particulate matter removal efficiency while also providing absorption capacity for undesirable vapors (e.g., toxic acid gases), and while operating at high gas flow velocities with continuous self-cleaning of the scrubbing element. The present apparatuses and methods also provide for gas treatment in a multi-pass fashion in the same small apparatus space as is required for single pass processes. Moreover, the present invention provides for the simultaneous action of the electrostatic precipitation, inertial impaction, adsorption, and absorption—which enables a multipollution control system by a single apparatus in a cost effective fashion.

The present apparatuses and methods provide for multiple electrical fields which may act in series or parallel on a gas stream, thus providing exceptionally high efficiency, redundancy, and reliability, and thus facilitating treatment of highly toxic gases laden with heavy metal, dioxins/furans, mercury, and similar chemical moieties that are exhausted, for instance, from incinerators and other processes. The present apparatuses and methods also provide for the capacity to treat a gas stream sequentially or simultaneously for at least two different pollutants in a gas stream via introducing different scrubbing liquids or reagents, e.g., in separate scrubbing sections but within the single apparatus. Moreover, the present apparatuses and methods provide an economically-feasible apparatus for treatment of corrosive gases, due to the fact that most of the internal components of the apparatus can be constructed from plastic (non-conductive) materials, such as, for example, FRP and/or PVC.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. An apparatus for removing particulate matter from a gas stream containing particulate matter, the apparatus comprising:
a voltage source;
an ionizing electrode connected to the voltage source for charging the particulate matter with a first polarity; and
a scrubbing element including a collecting surface, the scrubbing element being positioned proximate the ionizing electrode;
a liquid applicator operable to apply a scrubbing liquid to the collecting surfaces; and
a contact operable to apply a second polarity to the scrubbing liquid to attract the charged particulate matter from the gas stream.

2. The apparatus of claim 1, wherein the ionizing electrode is configured to charge condensed droplets of undesirable vapors in the gas stream, and wherein the scrubbing element includes packing for absorbing the condensed droplets of undesirable vapors from the gas stream.

3. The apparatus of claim 1, wherein the collecting surface extends in a direction that is substantially perpendicular to a flow direction of the gas stream.

4. The apparatus of claim 1, wherein the collecting surface is generally cylindrical in shape.

5. The apparatus of claim 1, wherein the scrubbing liquid flows on at least a portion of the collecting surface, at least in part, by gravity.

6. The apparatus of claim 1, wherein the contact is connected to the collecting surface.

7. The apparatus of claim 1, wherein the collecting surface is constructed, at least partially, of a conductive material.

8. The apparatus of claim 1 further comprising:
a conductive housing enclosing the scrubbing element, the liquid applicator and the ionizing electrode, the conductive housing being electrically isolated from the ionizing electrode; and
a sump coupled with the conductive housing, the sump being configured to maintain a liquid body in the conductive housing to be at a level for contacting with at least a portion of the scrubbing element.

9. The apparatus of claim 8, wherein the liquid applicator is configured to apply the scrubbing liquid in a substantially continuous film-wise or sheet-wise manner on the collecting surface.

10. The apparatus of claim 9, wherein the sump collects liquid flowing from the collecting surface and recycles the collected liquid to the liquid applicator.

11. The apparatus of claim 1, wherein the collecting surface is constructed at least partially of a non-conductive material.

12. The apparatus of claim 1, wherein the liquid applicator includes a spray nozzle.

13. A method for removing particulate matter from a gas stream containing particulate matter, the method comprising:
configuring an ionizing electrode in the gas stream;
configuring a scrubbing element proximate to the ionizing element;
charging the ionizing electrode to induce a negative charge on the particulate matter;
applying a substantially continuous liquid film to a collecting surface of the scrubbing element; and
positively charging the liquid film to attract the negatively-charged particulate matter.

14. The method of claim 13 wherein the step of configuring a scrubbing element comprises:
orienting a collecting surface of the scrubbing element to be generally perpendicular to a flow direction of the gas stream; and
disposing the scrubbing element downstream of the ionizing electrode.

15. The method of claim 13 further comprising:
enclosing the scrubbing element and the ionizing electrode in a conductive housing having a ground potential;
collecting, in a bottom portion of the conductive housing, a liquid pool being liquid film running off the collecting surface; and
maintaining contact of the liquid pool with the scrubbing element.

16. An apparatus for removing particulate matter from a gas stream containing first and second particulate matter, the apparatus comprising:
a first scrubbing module configured to remove the first particulate matter from the gas stream, the first scrubbing module including a first scrubbing element, a second scrubbing element, a first ionizing electrode intermediate the first and second scrubbing elements, and a first liquid applicator operable to apply a first scrubbing liquid to surfaces of the first and second scrubbing elements; and
a second scrubbing module configured to remove the second particulate matter from the gas stream, the second scrubbing module including a third scrubbing element, a fourth scrubbing element, a second ionizing electrode intermediate the third and fourth scrubbing elements, and a second liquid applicator operable to apply a second scrubbing liquid to surfaces of the third and fourth scrubbing elements; and
a voltage source connected to at least one of the first and second ionizing electrodes.

17. The apparatus of claim 16 wherein the first scrubbing module includes a first housing enclosing the first ionizing electrode, the first and second scrubbing elements, and the first liquid applicator,
and wherein the second scrubbing module includes a second housing enclosing the second ionizing electrode, the third and fourth scrubbing elements, and the second liquid applicator.

18. The apparatus of claim 16 wherein at least one of the first, second, third and fourth scrubbing elements extends in a direction that is substantially perpendicular to a flow direction of the gas stream.

19. The apparatus of claim 16 wherein at least one of the first, second, third and fourth scrubbing elements are generally cylindrical in shape.

20. The apparatus of claim 16 wherein at least one of the first and second ionizing electrodes includes front and back surfaces having an array of ionizing needles projecting outward therefrom
